(19) United States
(12) Patent Application Publication
(10) Pub. No.: US 2006/0032849 A1
(43) Pub. Date: Feb. 16, 2006

(54) Integrated die forming and welding process and apparatus therefor

(76) Inventors: Tad Vincent Machrowicz, Ortonville, MI (US); Terry Lawrence Bowman, Kendallville, IN (US)

Correspondence Address: GIFFORD, KRASS, GROH, SPRINKLE & CITKOWSKI, P.C, PO BOX 7021, TROY, MI, 48007-7021, US

(21) Appl. No.: 11/176,496

(22) Filed: Jul. 7, 2005

Related U.S. Application Data
(60) Provisional application No. 60/592,321, filed on Jul. 29, 2004.

(51) Int. Cl. H05B 6/10

(52) U.S. Cl. 219/633

(57) ABSTRACT

A forming system for shaping a metal article includes a pair of die members having a welding station associated therewith. The die members are operative to shape a workpiece disposed therebetween, and the welding station carries out welding operation on the article. The die members may be part of a die quench set which shapes and quenches a heated article. Welding may take place before, during, or after the shaping and quenching steps. Also disclosed are methods and specific apparatus for carrying out the invention.

### RELATED APPLICATION

This patent claims priority of provisional patent application Ser. No. 60/592,321 filed Jul. 29, 2004, and entitled “Integrated Die Forming and Welding Process and Apparatus Therefor.”

### FIELD OF THE INVENTION

This invention relates generally to welding. More specifically, the invention relates to a die forming process and apparatus wherein a welding step is carried out by, and within, the die.

### BACKGROUND OF THE INVENTION

Metals and other deformable materials are often shaped in a die forming process. A typical die forming apparatus includes a die set which has at least two die members which are movable relative to one another. The die members are configured to engage a workpiece disposed therebetween and, when urged together, to plastically deform the workpiece so as to produce a shaped article. In some instances, a die forming operation is carried out on a workpiece which is at ambient temperature; while in other die forming processes, workpieces are heated prior to, or during, the die forming process. Die quenching is one particular die forming process wherein heated workpieces are formed in a die set and subsequently quenched while still in the die set. In a typical die quenching process, a workpiece is heated to a first temperature which is above a metallurgical transition temperature, shaped in the die, and quenched to a second temperature which is below the metallurgical transition temperature. This process allows for the economical and controllable manufacture of high strength, hardened steel articles, among other things. One such die forming process is disclosed in U.S. Pat. Nos. 6,751,998; 6,640,595 and 6,185,978, the disclosures of which are incorporated herein by reference.

Frequently, it is necessary to carry out one or more welding operations on a workpiece which is to be, or has been, formed in a die forming process. In the prior art, such welding operations had to be carried out prior to, and/or after die forming. As will be described in detail hereinbelow, the present invention recognizes that welding operations may be integrated with a die forming process.

### BRIEF DESCRIPTION OF THE INVENTION

Disclosed herein is a forming die for shaping a metal article. The forming die includes a first and a second die member. At least one of the die members is movable relative to others so as to shape a workpiece disposed therebetween. The die further includes a welding station associated with at least one of the first and second die members. The welding station is operational to carry out a welding operation on a workpiece when it is disposed between the first and second die members.

In specific embodiments, the forming die is a die quenching die, operative to receive a workpiece which is heated to a first temperature which is greater than ambient, shape the workpiece, and quench the heated workpiece to a second temperature which is less than the first temperature. In this regard, the die quenching die includes a source of a quenchant fluid, such as a liquid or a gas, in communication therewith. In certain of these embodiments, the welding takes place when the workpiece is at a temperature above said second temperature, while in other instances, welding takes place after the workpiece has been cooled to said second temperature.

In the various embodiments, welding may be carried out by resistance welding or induction welding. In certain embodiments, the system includes a weld schedule controller which is in communication with the welding station. The controller is operable to control at least one parameter of the welding operation, and may do so in response to one or more parameters of the forming process.

Also disclosed herein is a method for forming articles through the use of the forming die of the present invention.

### BRIEF DESCRIPTION OF THE DRAWINGS

FIG. 1A is a cross-sectional view of a portion of a workpiece which may be shaped and welded in accord with the present invention;

FIG. 1B is a perspective view of portion of the workpiece of FIG. 1A after it has been shaped and welded through the use of the present invention;

FIG. 2 is a top plan view of a portion of a die member which may be utilized in the practice of the present invention; and

FIG. 3 is a cross-sectional view of the die member of FIG. 2 taken along line III-III.

### DETAILED DESCRIPTION OF THE INVENTION

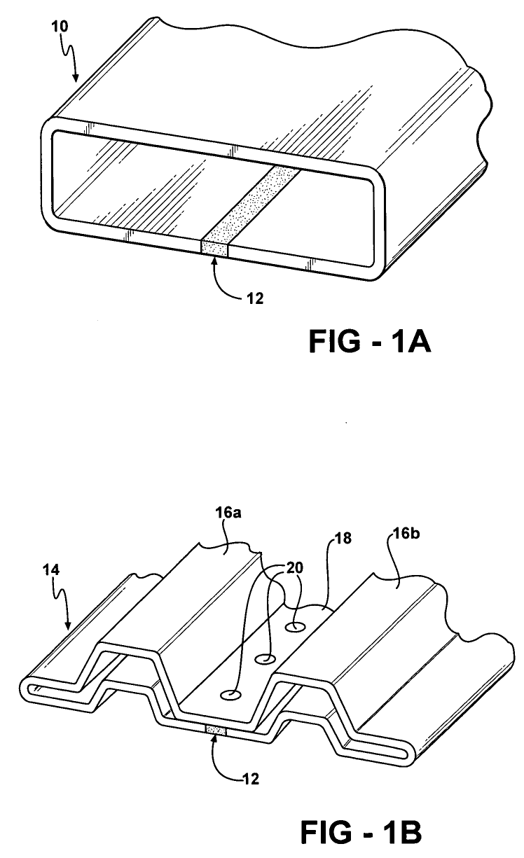

In accord with the present invention, one or more welding steps are carried out in a die forming process by modifying a forming die to include a welding station therein. By doing so, the need for a separate pre- or post-welding step is eliminated. Furthermore, welding may be advantageously carried out on a workpiece when it is compressed, and in some forming processes, at an elevated temperature. In order to better explain the environment in which the invention may, in one implementation, be carried out, reference is made to FIGS. 1A and 1B.

FIG. 1A depicts a workpiece 10 which is typical of a workpiece which may be employed, for example, to fabricate a reinforcement beam for a motor vehicle. The workpiece 10 comprises a body of sheet steel which has been roll formed, or otherwise shaped, into a closed profile, defining a flattened, hollow beam. As will be seen in FIG. 1A, the edges of the sheet steel have been welded together along seam line 12; although it is to be understood that in some instances, the workpiece may not be of a closed profile, and in other instances this welding step may also be carried out in the die forming process described below.

FIG. 1B depicts the workpiece 10 of FIG. 1A following a die forming process. As is shown in FIG. 1B, the workpiece has been reconfigured into a reinforcement beam 14 for a motor vehicle. As such, the beam 14 includes raised portions 16a, 16b and a flattened central portion 18. As is further shown in FIG. 1B, the flattened central portion 18 includes tack welds 20 which join the two surfaces of the beam 14 together. These welds 20 are formed according to the process of the present invention. In accord with the present invention, a forming die set is modified so as to include a welding station therein. In that regard, the welding station may be a resistance welding station or an induction welding station as is known in the art.

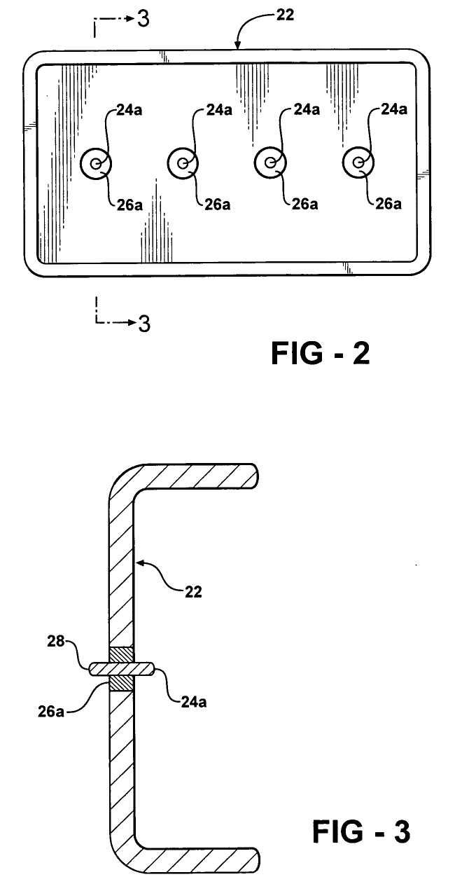

Referring now to FIG. 2, there is shown a top plan view of a portion of a forming die 22 which includes four welding electrodes 24a-24d therein. Each electrode 24 is disposed within an electrically insulating collar 26 so as to electrically isolate it from the remainder of the die 22. In those instances where the body of the die is non-metallic, it is possible to eliminate the insulating collars. As is understood in the art, these electrodes 24 may be resistance welding electrodes or they may be electrodes for an induction welding process. Typically, the electrodes will be made from a high strength electrically conductive material, and the insulating members 26 will, in some embodiments, be made from a ceramic material or from a high strength, high dielectric polymer. In those instances where the forming process is carried out on a heated workpiece, the electrodes and insulating bodies should be thermally stable. The electrodes may be spring loaded so as to allow them to maintain good electrical contact with the workpiece.

Referring now to FIG. 3, there is shown a cross-sectional view of the die of FIG. 2 taken along line III-III. As will be seen in FIG. 3, the electrode 24a is disposed so as to contact the workpiece within the die. Electrode 24a is also configured so as to allow for electrical connection thereto at a terminal end 28. In some instances, the die and electrodes may be configured so that electrodes may be removed and/or replaced. This will allow for repair of the system as well as permitting reconfiguration of the electrode distribution for specific applications.

In the use of the die 22 of FIGS. 2 and 3, a workpiece is disposed in contact with the die 22; and a counter die, not shown, is urged into contact with the die 22 so as to deform and shape the workpiece. The counter die is typically made from a metal and can serve as a counter electrode for the welding electrode 24a. In some instances, a dedicated electrode structure may also be disposed in the counter die.

In some instances, the die forming process is carried out on a workpiece at ambient temperature. In other instances, the workpiece is preheated, or heated in the die, to an elevated temperature. And yet other embodiments, as discussed above, the die forming process may be a die quenching process. In such instances, the die is operative to carry out a forming operation on a heated workpiece (either preheated or heated in the die) and then to quench that heated workpiece to a lower temperature by introducing a quenching fluid such as a gas or liquid into the die. In particular instance, the die quenching process is carried out so as to heat a workpiece to a first temperature which is above a metallurgical transition temperature, form the workpiece, and quench the workpiece to a second temperature which is below a metallurgical transition temperature. In this manner, high hardness, precisely shaped steel articles may be fabricated. In die quenching processes of this type, the welding step may be implemented before, during and/or after the forming and quenching steps.

In some instances, it may be desirable to vary the weld schedule over time and/or in response to conditions of temperature, pressure, quench rate, state of the workpiece and the like encountered in the process. For example, the weld current may be varied in this manner as may be the number, timing and/or duration of the weld pulses. Such control may be readily achieved by incorporating a weld controller into the circuit which activates the welding electrodes. The controller may, in some embodiments, be a programmed or programmable controller. In other instances, the controller may be a “smart” controller which senses one or more parameters of the process and/or materials communicated by associated sensors and controls the weld schedule accordingly.

The system of the present invention may be operated in various modes. For example, the invention may be adapted to cold forming dies as well as hot forming dies, including die quenching dies. One of skill in the art can readily, in view of the teaching presented herein, adapt and configure die forming apparatus for the practice of the present invention. Accordingly, many modifications and variations of the invention will be apparent to those of skill in the art in view of the teaching presented herein. The foregoing is illustrative of specific embodiments and implementations of the present invention, but is not meant to be a limitation upon the practice thereof. It is the following claims, including all equivalents, which define the scope of the invention.

1. A forming die for shaping a metal article, said forming die comprising:
a first die member;
a second die member, at least one of said first and second die members being movable relative to the other so as to shape a workpiece disposed therebetween; and
a welding station associated with at least one of said first and second die members, said welding station being operational to carry out a welding operation on said workpiece when it is disposed between said first and second die members.

2. The forming die of claim 1, wherein said forming die is a die quenching die operative to receive a workpiece which is heated to a first temperature which is greater than ambient and to shape said heated workpiece, said die quenching die being further characterized in that it is operational to quench the heated workpiece to a second temperature which is less than the first temperature.

3. The forming die of claim 2 further including a source of a quench fluid in communication therewith, for quenching the heated workpiece.

4. The forming die of claim 2, wherein said welding station is operational to weld said workpiece while it is at a temperature above said second temperature.

5. The forming die of claim 1, wherein said welding station is a resistance welding station.

6. The die of claim 1, wherein said welding station is an induction welding station.

7. The die of claim 1, further including a weld schedule controller in communication with said welding station, said controller being operable to control at least one parameter of said welding operation.

8. A method for die forming an article, said method comprising the steps of:
providing a forming die including a first die member, and a second die member, at least one of said first and second die members being movable relative to the other so as to shape a workpiece disposed therebetween;
providing a welding station associated with at least one of said first and second die members, said welding station being operational to carry out a welding operation on said workpiece;
disposing a workpiece in said forming die;
forming said workpiece in said forming die; and
performing a welding operation on said workpiece when it is in said forming die.

9. The method of claim 8, wherein said step of providing a forming die comprises providing a die quenching die which is operational to receive a workpiece which is heated to a first temperature which is above ambient, shape the heated workpiece and quench said workpiece to a second temperature which is less than said first temperature.

10. The method of claim 9, wherein said quenching die has a source of a quenching fluid in communication therewith.

11. The method of claim 9, wherein said workpiece is heated to a temperature which is above a metallurgical transition temperature before it is disposed in said die quenching die, and wherein the step of quenching said workpiece comprises quenching said workpiece to a second temperature which is less than said metallurgical transition temperature.

12. The method of claim 11, wherein said welding operation is carried out of said workpiece when it is at a temperature above said second temperature.

13. The method of claim 8, including the further step of varying at least one parameter of said welding process.

14. In a method for die forming an article, said method comprising the steps of: providing a metal workpiece which is to be formed, heating said workpiece to a temperature above ambient, providing a forming die, disposing said heated workpiece in said die and operating said die so as to change the shape of said workpiece, the improvement comprising:
providing a welding station in said die, and performing a welding operation on said workpiece when it is in said die.

15. The method of claim 14, wherein said welding operation is carried out on the workpiece when it is at a temperature above ambient.

16. The method of claim 14, wherein said forming die is a die quenching die which is operational to receive a workpiece which is heated to a first temperature and to quench said workpiece to a second temperature which is less than said first temperature, while said workpiece is in said die.

17. The method of claim 16, wherein said step of performing a welding operation is carried out prior to the quenching of said workpiece.

18. The method of claim 16, wherein said step of quenching is carried out after the step of performing the welding operation.

19. The method of claim 16, wherein said workpiece is heated to a first temperature which is above a metallurgical transition temperature.

20. The method of claim 14, including the further step of providing of a weld schedule controller which is in communication with said welding station and which is operational to control at least one parameter of the welding operation.
